(19) United States
(12) Patent Application Publication
(10) Pub. No.: US 2020/0090281 A1
(43) Pub. Date: Mar. 19, 2020

(54) Life Insurance Recommendation Engine

(71) Applicant: Everyday Life, Andover, MA (US)

(72) Inventor: Jacob Tamarkin, Andover, MA (US)

(21) Appl. No.: 16/563,412

(22) Filed: Sep. 6, 2019

Related U.S. Application Data
(60) Provisional application No. 62/728,683, filed on Sep. 7, 2018.

(51) Int. Cl. G06Q 40/08; G06Q 30/06; G06N 5/04

(52) U.S. Cl. CPC G06Q 40/08; G06Q 30/0643; G06N 5/04; G06Q 30/0631

(57) ABSTRACT

Systems and methods for recommending a life insurance policy to a user based on a relatively small amount of information and without requiring access to tax returns or any other financial or medical information. The systems and methods make educated inferences regarding income and expense factors. The systems and methods can make a recommendation for an annual amount of money required to replicate current living standards, read financial products available from third-party providers, and present the products for purchase. The life insurance policies can be laddered life insurance policies.

### CROSS-REFERENCE TO RELATED APPLICATIONS

This application claims priority to U.S. Provisional Patent Application No. 62/728,683 entitled “LIFE INSURANCE RECOMMENDATION ENGINE” filed Sep. 7, 2019 which is incorporated herein by reference in its entirety.

### BACKGROUND

Financial instruments like life insurance can be complicated products and are beyond the comprehension of many educated people. Conventionally they are highly user-specific and require a high level of analysis and thought to produce. For these reasons many people are underinsured or uninsured. Many people feel the products are too complicated to evaluate without professional assistance but also have difficulty obtaining cost-effective expert advice they can trust.

### SUMMARY

Embodiments of the present disclosure are directed to a method of recommending a life insurance policy, including receiving information from a user about the user including birthdate, gender, health rating, income, savings, and life insurance, wherein the information from the user comprises user-specific data. The method also includes accessing a public database to identify equivalency factors comprising information pertaining to individuals who share characteristics with the user based on the user-specific data, and compiling inferred data for the user based on the user-specific data and the public database. The method also includes calculating current and forecasted amounts of discretionary income in each of the user's anticipated working years based on the inferred data and the user-specific data, and forecasting household constraints for potential scenarios where the user dies this year or in any year during their forecasted life expectancy. The method continues by calculating an amount of money in each potential user death scenario needed to maintain each of the user's dependent's standard of living for the period in which that dependent may not yet be expected to be self-sufficient based on the user-specific data and the inferred data, compiling the money required under each scenario into a master forecast of money needed in each year of the user's life expectancy, and calculating one or more suggested life insurance policies. The method can then read available financial products capable of providing the money required, and present the available financial products to the user for purchase.

Further embodiments of the present disclosure are directed to a system for analyzing user inputs for the purpose of recommending a financial instrument purchase to a user. The system includes an input module configured to receive user-specific data from the user comprising birthdate, gender, health rating, income, savings, life insurance coverage, and residence, and an inference module configured to access a public database to identify characteristics of individuals who are similar to the user based on the user-specific data. Individuals who are highly similar to the user have a high equivalency factor with the user. The inference module is configured to forecast values for a financial characteristic of the user based on the equivalency factors. The system also includes an expense forecast module configured to forecast financial capabilities of the household taking into account that the user will perish, a budgeting module configured to calculate an amount of money per year will be needed by beneficiaries after the user is deceased based on the expense forecast module, and a financial instrument product catalog module configured to analyze existing third-party financial instrument provider's products and to identify one or more financial instruments to the user based on the budgeting module and the expense forecast module.

Still further embodiments are directed to a method of recommending a life insurance policy to a user. The method includes receiving user data from the user such as gender, health rating, income, savings, life insurance coverage, and residence. Without accessing any of the user's tax returns, financial statements, medical information, the method continues by accessing a public database to forecast future income and future expenses, calculating a forecasted amount of discretionary income for each of a predetermined number of years in the future, and factoring in the user's death into the future income, savings growth, and future expenses. The method also calculates calculating an annual amount of money required to maintain each of the dependents' standard of living enabled by the discretionary income, adjusted for future income, savings and expenses and replacement of caregiving services the user provides to each dependent, and identifies a laddered life insurance plan based on the amount of money required to maintain each of the dependents' standard of living for the period until the dependent can be expected to be self-sufficient, the laddered life insurance policy having at least two stages of different coverage. The method can also present to the user one or more life insurance products according to the stages of different coverage.

Embodiments of the present disclosure are directed to a method of recommending a life insurance policy, including receiving information from a user about the user birthdate, gender, overall health rating (excellent, very good, average, some issues), approximate annual gross income, approximate total retirement savings, approximate total non-retirement savings, approximate total unsecured debt, approximate total current life insurance coverage, residence, and number of dependents and about the dependents including relationship to user (i.e., spouse, child, parent or other adult), age, disability status (spousal and child dependents only), employment status (spousal dependents only), and if user provides primary caregiving support (child and parent or other adult dependents only). The information from the user comprises user-specific data. The method also includes accessing a public database to identify equivalency factors comprising information pertaining to individuals who share at least one characteristic with the user based on the user-specific data. The method further includes compiling inferred data for the user based on the user-specific data and the public database, and calculating an amount of discretionary income based on the inferred data and the user-specific data. The method also includes forecasting household constraints for after the user dies, and calculating an amount of money that will be needed to replace the discretionary income necessary to maintain the user's dependents after the user dies based on the user-specific data and the inferred data. The amount of money is used to calculate a suggested life insurance policy. The method continues by reading available financial products capable of providing the amount of money to the user, and presenting the available financial products to the user for purchase.

In some embodiments of the present disclosure the method also includes presenting to the user an ideal insurance product, comparing the ideal insurance product to the available financial products, and calculating an overlap/underlap.

Further embodiments of the present disclosure are directed to a system for analyzing user inputs for the purpose of recommending a financial instrument purchase to a user. The system can include an input module configured to receive user-specific data from the user comprising birthdate, gender, overall health rating (excellent, very good, average, some issues), approximate annual gross income, approximate total retirement savings, approximate total non-retirement savings, approximate total unsecured debt, approximate total current life insurance coverage, residence, and number of dependents and about the dependents including relationship to user (i.e., spouse, child, parent or other adult), age, disability status (spousal and child dependents only), employment status (spousal dependents only), and if user provides primary caregiving support (child and parent or other adult dependents only), and an inference module configured to access a public database to identify individuals who are similar to the user based on the user-specific data. Individuals who are highly similar to the user have a high equivalency factor with the user. The inference module is configured to forecast values for a financial characteristic of the user based on the equivalency factors. The system also includes an expense forecast module configured to forecast financial capabilities of the household taking into account that the user will perish, and a budgeting module configured to calculate an amount of money per year will be needed by beneficiaries after the user is deceased based on the expense forecast module. The system also includes a financial instrument product catalog module configured to analyze existing third-party financial instrument provider's products and to identify one or more financial instruments to the user based on the budgeting module and the expense forecast module.

Further embodiments of the present disclosure are directed to a method of recommending a life insurance policy to a user including receiving user data from the user, the user data comprising birthdate, gender, overall health rating (excellent, very good, average, some issues), approximate annual gross income, approximate total retirement savings, approximate total non-retirement savings, approximate total unsecured debt, approximate total current life insurance coverage, residence, and number of dependents and about the dependents including relationship to user (i.e., spouse, child, parent or other adult), age, disability status (spousal and child dependents only), employment status (spousal dependents only), and if user provides primary caregiving support (child and parent or other adult dependents only). Without accessing any of the user's tax returns or other financial or medical records or information, the method includes accessing a public database to forecast future income and future expenses, and calculating an amount of discretionary income for each of a predetermined number of years in the future. The method also includes factoring in the user's death into the future income and future expenses, and calculating an annual amount of money required to maintain the dependents' standard of living for the period until they are expected to become self-sufficient (if ever). The method also includes identifying a laddered life insurance policy based on the user data, the forecast future income, and the future expenses. The laddered life insurance policy has at least two stages of different coverage. The system is also configured to present to the user one or more life insurance products according to the stages of different coverage.

### BRIEF DESCRIPTION OF THE FIGURES

FIG. 1 is a schematic illustration of a life insurance data acquisition system according to embodiments of the present disclosure.

FIG. 2 is a schematic illustration of a recommendation engine according to embodiments of the present disclosure.

FIG. 3 shows a method for recommending a life insurance policy to a user according to embodiments of the present disclosure.

FIG. 4 shows a method for recommending a life insurance policy according to embodiments of the present disclosure including aspects described above in a unifying manner.

FIG. 5 and the corresponding discussion are intended to provide a brief, general description of a suitable computing environment in which embodiments may be implemented.

### DETAILED DESCRIPTION

Below is a detailed description according to various embodiments of the present disclosure. Life insurance products, like many financial instruments, are poorly understood by the general public who are then underserved by existing financial providers. The process of obtaining all the information required for selecting a policy is daunting for many people. Insurance providers have been unable to identify how to best reach this potentially large market and instead have focused mostly on individuals of higher net worth who have the financial means and knowledge to understand and afford their products. There is a need in the art for a product that is accessible to those without an affinity to financial products or the resources to engage professional advisors. The following is a description of various computer-enabled products that are able to overcome these deficiencies.

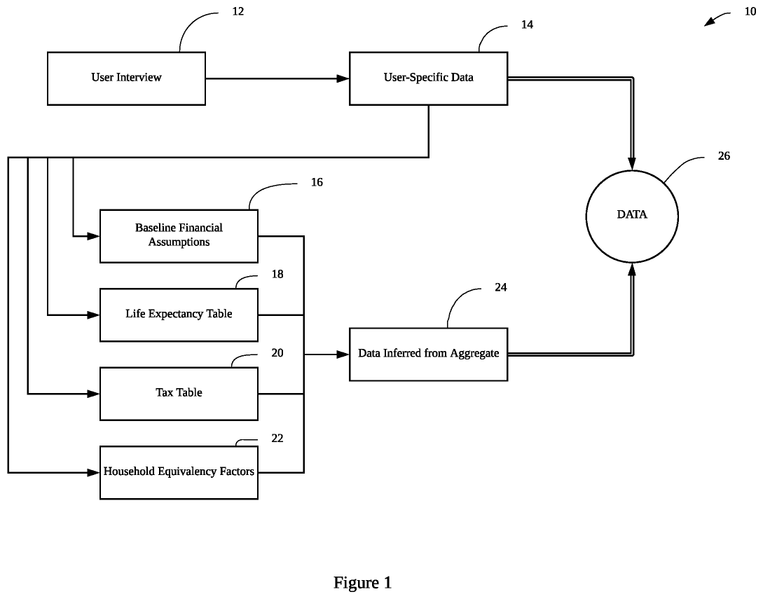

FIG. 1 is a schematic illustration of a life insurance data acquisition system 10 according to embodiments of the present disclosure. The system 10 can be run via a web browser as is well known in today's electronic market. A user interview 12 can be conducted whereby the system presents the user with certain questions and records the responses. Basic demographic information such as birthdate, gender, overall health rating (excellent, very good, average, some issues), approximate annual gross income, approximate total retirement savings, approximate total non-retirement savings, approximate total unsecured debt, approximate total current life insurance coverage, residence, and number of dependents and about the dependents including relationship to user (i.e., spouse, child, parent or other adult), age, disability status (spousal and child dependents only), employment status (spousal dependents only), and if user provides primary caregiving support (child and parent or other adult dependents only) can be gathered as user-specific data 14. In general, the interview can be limited to information that an average user will know off the top of their head without accessing financial documents such as tax returns or W-2 forms, etc. The user-specific data 14 is one component of the full data 26 that will be used to generate discounted cash flow analysis that can then be used to recommend an insurance product.

A second component of the data 26 is data inferred from aggregate sources 24. In certain embodiments of the present disclosure, after receiving the user-specific information the system 10 accesses certain databases such as tax tables and U.S. Census Bureau information and makes certain assumptions based on the user-specific information and calculates the inferred data 24. The baseline assumptions 16 can include such things as rates of individual savings and income growth, investment returns, and inflation. The assumptions can also include items such as the user's retirement age, how many years it will take a surviving dependent spouse/partner or child to become financially self-sufficient (or if such self-sufficiency is possible at all), and how much it may cost to replace any non-financial services the user currently provides to each dependent, such as caregiving. Other data points include life expectancy tables 18 and tax tables 20, each of which is an example of publicly available information that can be used by the system 10 to provide a better insurance product by inferring certain information rather than relying on detailed, user-specific information.

For example consider a surviving spouse who has not been the primary earner and is now faced with the loss of spouse. It is possible the surviving spouse can begin to provide for themselves, and this process can take time. The amount of time it takes is part of the baseline financial assumptions based on how long it has taken other people who are similarly situated. In some cases, however, the surviving spouse cannot increase their earning potential, either because they were already working and therefore cannot simply add a full-time job, or because of a disability or other reason they were not working before the insured passed. There is a wealth of publicly available information on such matters and the present disclosure is configured to access these resources. Compare this approach with currently available financial service products where an in-person interview would be necessary to determine how long each person would take to reach self-sufficiency and it becomes clear how difficult and time-consuming that process would be. Rather, the present disclosure relies on statistical information gleaned from large databases.

The user-specific data 14 is used to in connection with the aggregated data to achieve information for the user without requiring access to financial or medical documents. There are many variables that affect these calculations. Two of these variables are age and location. For example, academic research suggests that a 23 year old in New York City earning $100,000 is likely to experience a higher rate of inflation-adjusted income growth in future years than a 47 year old in Dubuque, Iowa who also currently earns $100,000. From the user-specific data 14 the system 10 knows the age and location of the individual and compares to other, similarly aged and located people to establish a reasonable estimation of future income growth.

The system 10 implements household equivalency factors 22 to estimate the potential diseconomies of scale that may occur in a household's expenses if a user were removed from the household. When a person dies, some expenses are reduced and others are not. Take for example food that is no longer consumed by someone after they die, and compare it to housing expenses that are much more unlikely and difficult to reduce by that person's fractional share of expenses.

The result of using the baseline financial assumptions 16, life expectancy table 18, tax table 20, and household equivalency factors 22 is data inferred from Aggregate 24. Using this data, there is perhaps some sacrifice of accuracy by relying on statistics coming from large data samples, but the tradeoff is a much greater accessibility and easier presentation to an average user. There is no need to access a tax return or any other financial or medical document from the user. Tests indicate that most people will know the information at a moment's notice without consulting any notes or other document.

In some embodiments the user is presented with the opportunity to view and alter the baseline financial assumptions to more particularly address their specific needs. There may be a default set of assumptions that are applied, and these are presented to the user who may then make certain changes. The changes the user includes can be factored into the calculation.

Combining the user-specific data 14 with the aggregate data 24 is a composite data set 26 that can be entered into a calculation as will be shown. The data 26 can be used to recommend life insurance, but other financial instruments are also possible, including annuities, investments, or other types of insurance such as disability insurance.

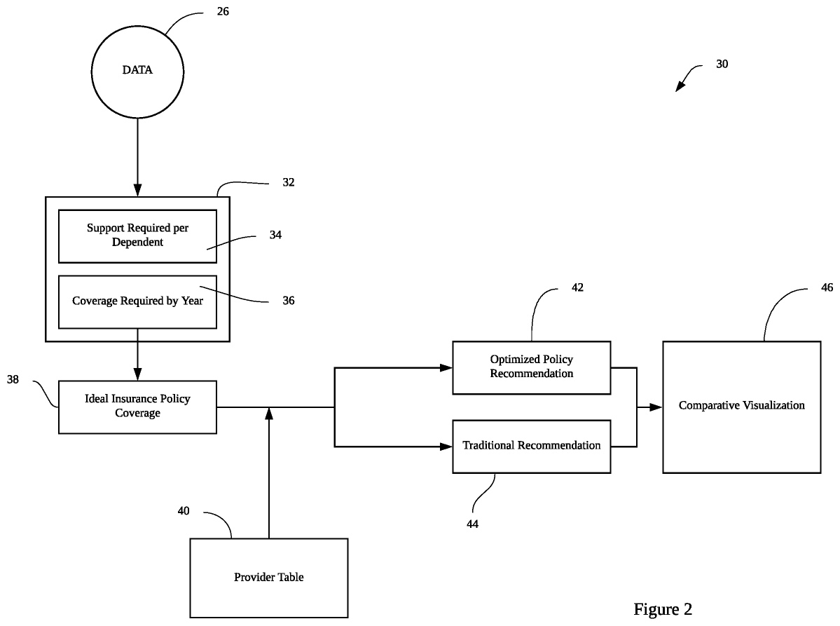

FIG. 2 is a schematic illustration of a recommendation engine 30 according to embodiments of the present disclosure. The engine 30 receives the data 26 from the system 10 shown in FIG. 1. The engine 30 includes a calculation component 32 that is configured to determine how much support will be required per dependent per year. Characteristics such as disabilities of the dependents factor in to this calculation. Most children eventually grow up and leave the house and are no longer receiving support from the insured, but some face situations where they will not do so.

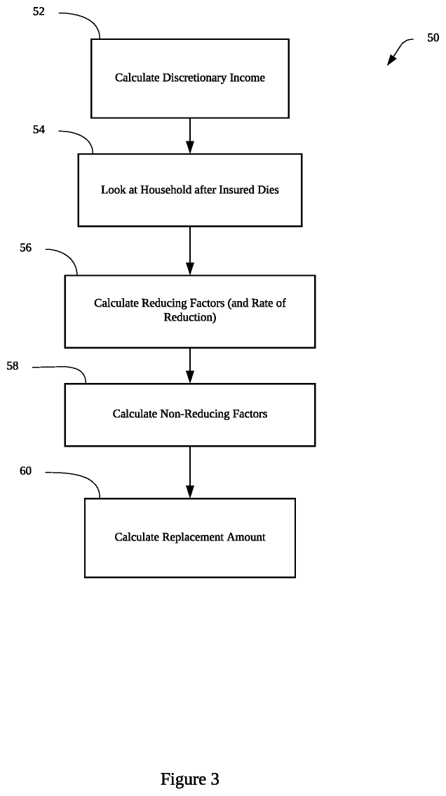

The support is based on the user's current income and other baseline assumptions. In some embodiments the analysis is shown in FIG. 3. A method 50 includes at 52 calculating discretionary income for the household at the current time. Using the household equivalency factors this number can be forecast into the future to account for expected wage growth or other changes. At 54 changes to the household are considered after the insured dies. At 56 the method includes calculating factors that reduce after the insured passes, and a rate at which the expenses will change. At 58 calculate which factors will not materially change upon the insured's death. The method continues at 60 by calculating how much money would be needed to replace the discretionary income calculated at 52. The result is a year-by-year amount that is used to recommend a life insurance policy.

Referring back to FIG. 2, an “ideal” insurance policy 38 is the result of the recommendation engine 30. Insurance policies are not individually tailored down to the penny; rather, such products are sold in round number amounts. The engine 30 can access provider tables 40 by reading from websites of insurance providers their available insurance products. An optimized policy recommendation 42 is the exact calculation that is the result of the calculation component 32, and a traditional recommendation 44 is used for comparison in a visualization 46 to show a degree of overlap/underlap between the two. The degree of difference may vary, and in many cases people will choose to round up to the nearest dollar amount. Of course, a choice is presented to the user to elect a higher or lower amount of coverage if they so choose.

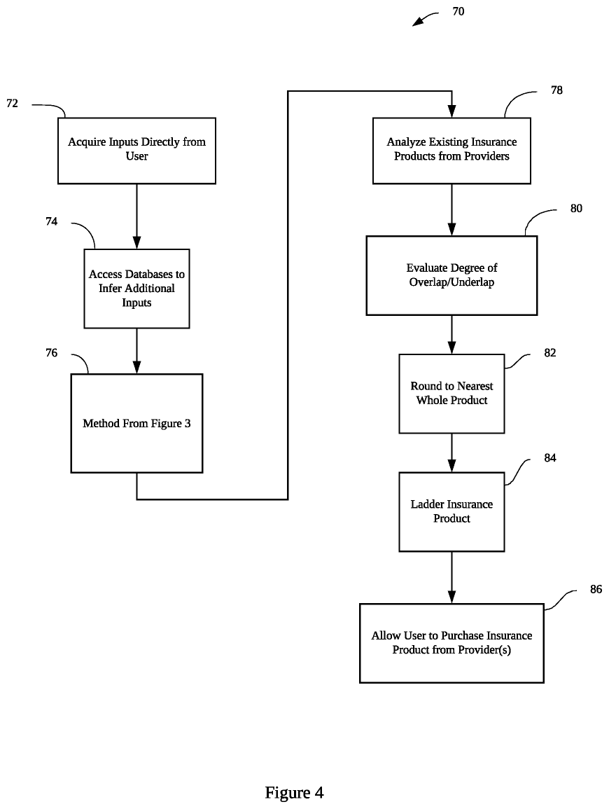

FIG. 4 shows a method 70 for recommending a life insurance policy according to embodiments of the present disclosure including aspects described above in a unifying manner. The method 70 can be executed by a computer system operating various algorithms that receive inputs from a user via a website on a desktop computer or a mobile device and presents information also via the web interface. In other embodiments a similar method can be executed in-person in an office in a more traditional setting without departing from the spirit of the disclosure. Beginning at 72 the computer system accepts inputs from a user such as demographic information, employment information, location, age, etc. This is the “user-specific” data. At 74 the system accesses databases such as U.S. Census Bureau and others and infers additional data based on statistical analysis of the information in the databases. This is the “aggregated” data. At 76 the system applies the method shown and described with respect to FIG. 3. The outcome of the method of FIG. 3 can be a year-by-year dollar value representing the amount of money that would be required to as nearly as possible account for the loss of the insured.

At 78 the system analyzes existing insurance products from providers. This can be executed by reading and analyzing prices and availability from financial provider's websites, from brokerage firms, and from any other publicly available listing of financial services. At 80 each policy is evaluated to determine a degree of overlap/overlap with the “ideal” coverage. For example, the ideal coverage amount may be an odd number such as $4,560.00, where the policies are given in terms of $5,000.00 increments in which case the overlap would be $440.00. At 82 the system can round to the nearest whole product, and can display the overlap/underlap.

At 84 a laddered insurance product is presented. A laddered insurance product is one that has stages of differing policy coverage. One example of a laddered approach would be one that has a different coverage amount each year, and each year it changes. In some embodiments the rungs of the ladder trigger at the occurrence of certain life events. For example, a couple sending a child to college will experience a significant change in their financial picture. Such an event can trigger a ladder rung to change. The system of the present disclosure can monitor the rungs of the ladders and can automate the process of changing the insurance policies at the defined times.

At 86 the system can allow the user to make a purchase of one or more of the financial products presented in the amounts nearest to the calculated ideal. The system can direct a user directly to the provider's site with certain arguments according to the user-specific and inferred data. In some embodiments the system can execute the sale of the financial products on behalf of the user. The system can accordingly operate as a purchasing agent for the user. The system can elect to share certain details of the representation and the user's identity with the provider, or these details can be withheld.

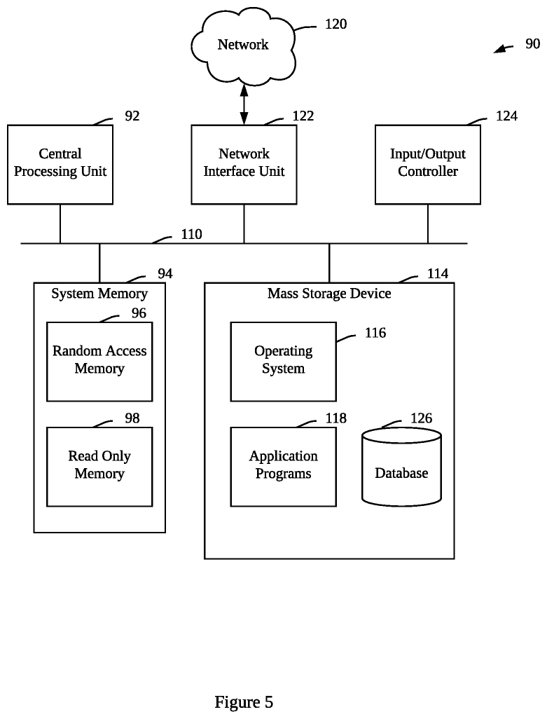

FIG. 5 and the corresponding discussion are intended to provide a brief, general description of a suitable computing environment in which embodiments may be implemented. Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 5, an illustrative computer architecture for a computer 90 utilized in the various embodiments will be described. The computer architecture shown in FIG. 5 may be configured as a desktop or mobile computer and includes a central processing unit 92 (“CPU”), a system memory 94, including a random access memory 96 (“RAM”) and a read-only memory (“ROM”) 98, and a system bus 110 that couples the memory to the CPU 92.

A basic input/output system containing the basic routines that help to transfer information between elements within the computer, such as during startup, is stored in the ROM 98. The computer 90 further includes a mass storage device 14 for storing an operating system 16, application programs 18, and other program modules, which will be described in greater detail below.

The mass storage device 114 is connected to the CPU 92 through a mass storage controller (not shown) connected to the bus 110. The mass storage device 114 and its associated computer-readable media provide non-volatile storage for the computer 90. Although the description of computer-readable media contained herein refers to a mass storage device, such as a hard disk or CD-ROM drive, the computer-readable media can be any available media that can be accessed by the computer 90. The mass storage device 114 can also contain one or more databases 126.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 90.

According to various embodiments, computer 90 may operate in a networked environment using logical connections to remote computers through a network 120, such as the Internet. The computer 90 may connect to the network 120 through a network interface unit 122 connected to the bus 110. The network connection may be wireless and/or wired. The network interface unit 122 may also be utilized to connect to other types of networks and remote computer systems. The computer 90 may also include an input/output controller 124 for receiving and processing input from a number of other devices, including a keyboard, mouse, or electronic stylus (not shown). Similarly, an input/output controller 124 may provide output to a display screen, a printer, or other type of output device (not shown).

As mentioned briefly above, a number of program modules and data files may be stored in the mass storage device 114 and RAM 96 of the computer 90, including an operating system 116 suitable for controlling the operation of a networked personal computer. The mass storage device 114 and RAM 96 may also store one or more program modules. In particular, the mass storage device 114 and the RAM 96 may store one or more application programs 118.

The foregoing disclosure hereby enables a person of ordinary skill in the art to make and use the disclosed systems without undue experimentation. Certain examples are given to for purposes of explanation and are not given in a limiting manner.

1. A method of recommending a life insurance policy, the method comprising:
receiving information from a user about the user including birthdate, gender, health rating, income, savings, and life insurance, wherein the information from the user comprises user-specific data;
accessing a public database to identify equivalency factors comprising information pertaining to individuals who share characteristics with the user based on the user-specific data;
compiling inferred data for the user based on the user-specific data and the public database;
calculating current and forecasted amounts of discretionary income in each of the user's anticipated working years based on the inferred data and the user-specific data;
forecasting household constraints for potential scenarios where the user dies this year or in any year during their forecasted life expectancy;
calculating an amount of money in each potential user death scenario needed to maintain each of the user's dependent's standard of living for the period in which that dependent may not yet be expected to be self-sufficient based on the user-specific data and the inferred data;
compiling the money required under each scenario into a master forecast of money needed in each year of the user's life expectancy;
calculating one or more suggested life insurance policies;
reading available financial products capable of providing the money required; and
presenting the available financial products to the user for purchase.

2. The method of claim 1, further comprising executing a purchase of the products.

3. The method of claim 1 wherein the user-specific data further comprises information regarding dependents, including a capability of the dependents and care support given by the dependents or to the dependents.

4. The method of claim 1 wherein calculating an amount of discretionary income comprises estimating tax rates and savings rates for the user and projecting future income growth, wherein the tax rates, savings rates, and income growth rates are calculated using the inferred data.

5. The method of claim 1 wherein forecasting household constraints comprises calculating a factor by which the financial cost of each of the dependent's current standard of living will change upon the death of the user and calculating for each dependent the number of years until they may be self-sufficient using the inferred data.

6. The method of claim 1, further comprising:
presenting to the user an ideal insurance product;
comparing the ideal insurance product to the available financial products; and
calculating an overlap/underlap.

7. The method of claim 1 wherein compiling the inferred data comprises forecasting an income growth for the user.

8. The method of claim 1 wherein equivalency factors comprise identifying individuals facing circumstances similar to the user-specific data.

9. The method of claim 1 wherein accessing the public database comprises using baseline assumptions about the user and accessing a tax table, U.S. Census Bureau data, or a life expectancy table.

10. The method of claim 9, further comprising receiving an input from the user to alter the baseline assumptions.

11. The method of claim 1 wherein presenting available financial products for purchase comprises acting as a purchasing agent for the user.

12. The method of claim 1 wherein presenting available financial products for purchase comprises a visualization of a comparison of the suggested life insurance policy and the available financial products.

13. The method of claim 1, further comprising calculating a laddered insurance strategy having at least two stages of coverage.

14. A system for analyzing user inputs for the purpose of recommending a financial instrument purchase to a user, the system comprising:
an input module configured to receive user-specific data from the user comprising birthdate, gender, health rating, income, savings, life insurance coverage, and residence;
an inference module configured to access a public database to identify characteristics of individuals who are similar to the user based on the user-specific data, wherein individuals who are highly similar to the user have a high equivalency factor with the user, wherein the inference module is configured to forecast values for a financial characteristic of the user based on the equivalency factors;
an expense forecast module configured to forecast financial capabilities of the household taking into account that the user will perish;
a budgeting module configured to calculate an amount of money per year will be needed by beneficiaries after the user is deceased based on the expense forecast module; and
a financial instrument product catalog module configured to analyze existing third-party financial instrument provider's products and to identify one or more financial instruments to the user based on the budgeting module and the expense forecast module.

15. The system of claim 14 wherein the user-specific data further comprises information about dependents including relationship to user, dependent capabilities, and whether or not the user provides primary caregiving support to the dependent.

16. The system of claim 14 wherein the financial instruments comprise at least one of life insurance, mutual funds, or annuities.

17. The system of claim 14 wherein the financial characteristic of the user comprises at least one of income, expenses, debt, and investments.

18. The system of claim 14 wherein the expense forecast module is configured to identify a first set of financial capabilities that are not materially changed by the user's death and a second set of financial capabilities that are materially changed by the user's death.

19. The system of claim 14 wherein the financial instrument product catalog module is further configured to enable the user to purchase the financial instrument.

20. A method of recommending a life insurance policy to a user, the method comprising:
receiving user data from the user, the user data comprising birthdate, gender, health rating, income, savings, life insurance coverage, and residence;
without accessing any of the user's tax returns, financial statements, medical information, accessing a public database to forecast future income and future expenses;
calculating a forecasted amount of discretionary income for each of a predetermined number of years in the future;
factoring in the user's death into the future income, savings growth, and future expenses;
calculating an annual amount of money required to maintain each of the dependents' standard of living enabled by the discretionary income, adjusted for future income, savings and expenses and replacement of caregiving services the user provides to each dependent;
identifying a laddered life insurance plan based on the amount of money required to maintain each of the dependents' standard of living for the period until the dependent can be expected to be self-sufficient, the laddered life insurance policy having at least two stages of different coverage; and
presenting to the user one or more life insurance products according to the stages of different coverage.

21. The method of claim 20 wherein the user data comprises dependent information including relationship of the dependent to the user, capabilities of the dependent, and whether or not the user is responsible for primary caregiving for the dependent.

22. The method of claim 20 wherein identifying a laddered life insurance plan comprises reading available life insurance policies from one or more third-party providers and identifying the policy provides the required coverage in a manner where the coverage provided changes over time in order to meet the coverage requirements in the most cost-effective manner.

23. The method of claim 20, further comprising presenting to the user a comparison of the annual amount of additional money required to:
maintain each the dependents' standard of living provided by the user;
the two or more stages of different coverage; and
the coverage provided by a single insurance policy alternative.
